(19) United States
(12) Patent Application Publication
(10) Pub. No.: US 2008/0019488 A1
(43) Pub. Date: Jan. 24, 2008

(54) Communication system and voice message processing method used in communication system

(75) Inventors: Seiji Tani, Fussa-shi (JP); Shuichi Sato, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/878,057

(22) Filed: Jul. 20, 2007

(30) Foreign Application Priority Data
Jul. 21, 2006 (JP) 2006-199572

(51) Int. Cl. H04M 1/64

(52) U.S. Cl. 379/88.23

(57) ABSTRACT

According to one embodiment, a communication system includes a plurality of voice mail apparatuses which include mailboxes corresponding to a plurality of telephone terminals, and record a voice message transmitted to any one of the plural telephone terminals in a mailbox corresponding to the telephone terminal and a file server which is connected to each of the plural voice mail apparatuses via a network and includes a plurality of common mailboxes to be used in common with the plural voice mail apparatuses, wherein each of the plurality of voice mail apparatuses include a controller which transfers the voice message to the file server via the network in order to record the voice message in any one of the common mailboxes, when there is a request to record the voice message.

### CROSS-REFERENCE TO RELATED APPLICATIONS

This application is based upon and claims the benefit of priority from Japanese Patent Application No. 2006-199572, filed Jul. 21, 2006, the entire contents of which are incorporated herein by reference.

### BACKGROUND

1. Field

One embodiment of the present invention relates to a communication system provided with a plurality of telephone terminals and a voice message processing method used in the communication system and, more particularly, to a communication system for recording a voice message input from a telephone terminal of a transmission source in a mailbox apparatus.

2. Description of the Related Art

Up to now, many of telephone exchange apparatuses such as private branch exchanges (PBXs) and key telephone apparatuses are used in, for example, office buildings and business premises. A voice mail apparatus for recording a voice message is connected to such a telephone exchange apparatus. The telephone exchange apparatus transfers, when an extension telephone accommodated therein is unresponsive due to talking on the telephone, absence or the like, an incoming call for the extension telephone to a voice mail apparatus.

After a start of a system operation, there arises a need for addition of a voice mail apparatus to the telephone exchange apparatus or a need for an increase in the number of telephone exchange apparatuses in some cases. Jpn. Pat. Appln. KOKAI Publication No. 2004-320629 discloses a system in which a voice mail apparatus is provided on a computer network such as a local area network (LAN), and a voice message can be recorded on or played back from the voice mail apparatus by a communication terminal via a telephone exchange apparatus.

It is quite probable that an abnormality will occur in a hard disk, power supply and the like, even in the voice mail apparatus described above. In such a case, a method is considered for connecting an external storage apparatus to the voice mail apparatus. However, each time a voice mail apparatus is added to the system or a system alteration is made, control programs and prompt data must be updated for each of external storage apparatuses connected to each voice mail apparatuses, which requires much time and labor for the maintenance of the external storage apparatuses.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of a communication system according to a first embodiment of the present invention.

FIG. 2 is a block diagram showing an internal configuration of a voice mail apparatus shown in FIG. 1.

FIG. 3 is a flowchart showing procedures to be performed by a CPU of the voice mail apparatus when a voice message is recorded on a file server in the first embodiment.

FIG. 4 is a flowchart showing procedures to be performed by a CPU of the voice mail apparatus when a voice message cannot be recorded on a file server in a second embodiment of the present invention.

FIG. 5 is a flowchart showing procedures to be performed by a CPU of the voice mail apparatus at the start-up time of the voice mail apparatus in a third embodiment of the present invention.

### DETAILED DESCRIPTION

Various embodiments according to the invention will be described hereinafter with reference to the accompanying drawings, in general, according to one embodiment of the invention, a communication system includes a plurality of voice mail apparatuses each of which includes mailboxes corresponding to a plurality of telephone terminals, and records a voice message transmitted to any one of the plural telephone terminals in a mailbox corresponding to the telephone terminal; and a file server which is connected to each of the plural voice mail apparatuses via a network and includes a plurality of common mailboxes to be used in common with the plurality of voice mail apparatuses, wherein each of the plurality of voice mail apparatuses include a controller which transfers the voice message to the file server via the network in order to record the voice message in any one of the common mailboxes, when there is a request to record the voice message.

### First Embodiment

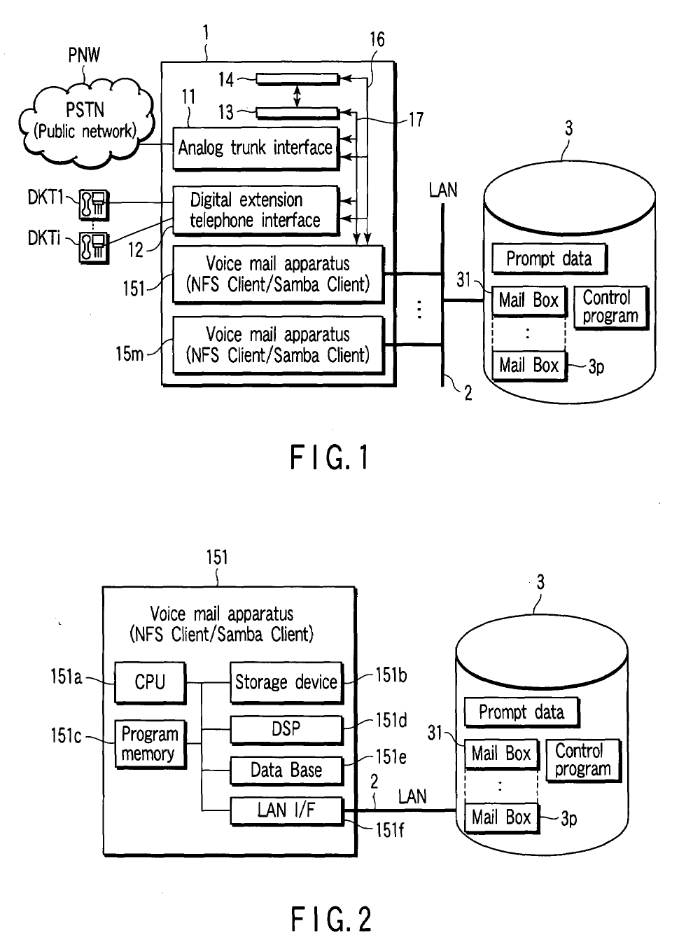

FIG. 1 is a block diagram showing a configuration of a communication system according to a first embodiment of the present invention.

A telephone exchange apparatus 1 comprises an analog trunk interface 11, digital extension telephone interface 12, time switch 13, central control unit 14, and a plurality of voice mail apparatuses 151 to 15m (m is a natural number). The analog trunk interface 11, digital extension telephone interface 12, central control unit 14, and voice mail apparatuses 151 to 15m are connected to each other via a control bus 16. Further, the analog trunk interface 11, digital extension telephone interface 12, time switch 13, and voice mail apparatuses 151 to 15m are connected to each other via a voice bus 17.

A plurality of extension terminals DKT1 to DKTi (i is a natural number) are accommodated in the digital extension telephone interface 12. As the extension terminals DKT1 to DKTi, for example, digital key telephones are used. The digital extension telephone interface 12 performs transmission/reception processing and transfer processing of digital signals for the extension terminals DKT1 to DKTi.

The analog trunk interface 11 is connected to a public network PNW and performs establishment processing of a voice link between outside line terminals connected to the public network PNW and the extension terminals DKT1 to DKTi.

The time switch 13 performs processing of changeover between the analog trunk interface 11, digital extension telephone interface 12, and voice mail apparatuses 151 to 15m in accordance with an instruction from the central control unit 14.

The central control unit 14 has ordinary control functions of performing transmission processing incidental to a call request from each of the extension terminals DKT1 to DKTi, reception processing incidental to an incoming call from the public network PNW, processing of transfer between the extension terminals DKT1 to DKTi, and the like. Furthermore, the central control unit 14 has an incoming call answering function. This incoming call answering function calls out the voice mail apparatus 151 for an incoming call when the extension terminal DKT1 which is an incoming call destination is unresponsive, and connects the voice mail apparatus 151 to the transmission source in order to cause the voice mail apparatus 151 to transmit predetermined guidance to the transmission source.

Each of the voice mail apparatuses 151 to 15m has a plurality of mailboxes in which voice messages are accumulated in a predetermined file format. These mailboxes are made to correspond to the respective extension terminals DKT1 to DKTi in advance. Each of the voice mail apparatuses 151 to 15m accumulates voice messages from transmission sources in mailboxes corresponding to the extension terminals to which the voice messages are addressed.

A file server 3 is connected to the plural voice mail apparatuses 151 to 15m via a local area network (LAN) 2. The file server 3 is composed of a CPU, hard disk, and the like, and is provided with a plurality of mailboxes 31 to 3p which are used in common with the plural voice mail apparatuses 151 to 15m. The file server 3 further stores therein a control program and prompt data used to record voice messages in the mailboxes 31 to 3p. The file server 3 converts voice message data coming from the LAN 2 into data of a file format that can be processed by the voice mail apparatuses 151 to 15m, and records the converted data in an arbitrary one of the mailboxes 31 to 3p on the basis of the control program. Further, the control program has a function of playing back a voice message recorded in any one of the mailboxes 31 to 3p in accordance with a playback instruction from any one of the voice mail apparatuses 151 to 15m. The prompt data is voice guidance data out put to the respective extension terminals DKT1 to DKTi or display data displayed on a screen of a terminal when the voice message is recorded or played back.

Furthermore, in an operating system (OS) of the file server 3, a common file server is set. For example, when the OS is Windows (trademark), the Samba server is set therein. In the case of Unix or Linux, the NFS server is set. All of them are functions of the OSs.

Next, the configuration of the voice mail apparatuses 151 to 15m will be described below. The voice mail apparatus 151 will be described here as a representative one. As shown in FIG. 2, the voice mail apparatus 151 comprises a CPU 151a, storage device 151b, program memory 151c, digital signal processor (DSP) 151d, database 151e, and LAN interface 151f.

The storage device 151b is provided with mailboxes corresponding to the respective extension terminals DKT1 to DKTi. Correspondence between the extension terminals DKT1 to DKTi and the mailboxes is stored in the database 151e. The above-mentioned control program and the prompt data are stored in the program memory 151c.

The DSP 151d has a function of adjusting a voice signal level to a specified level. When storing a voice message in a mailbox or when playing back a voice message from a mailbox, the CPU 151a adjusts the signal level of the voice message by means of the DSP 151d.

The LAN interface 151f transmits or receives data to or from the file server 3 via the LAN 2.

Furthermore, the CPU 151a has, in addition to the ordinary control function relevant to recording and playback of a voice message, as a new function according to the present invention, a function of transmitting a voice message to the file server 3 via the LAN 2 when it receives a request to record a voice message, and causing the file server 3 to record the voice message in a mailbox 31 corresponding to the extension terminal DKT1 which is the transmission destination of the voice message. The CPU 151a further has a function of playing back a voice message recorded in the mailboxes 31 to 3p in the file server 3 in response to a request to play back a voice message. Moreover, the CPU 151a has a function of mounting the file server 3 connected to the LAN 2 as an external storage device when the power supply is started.

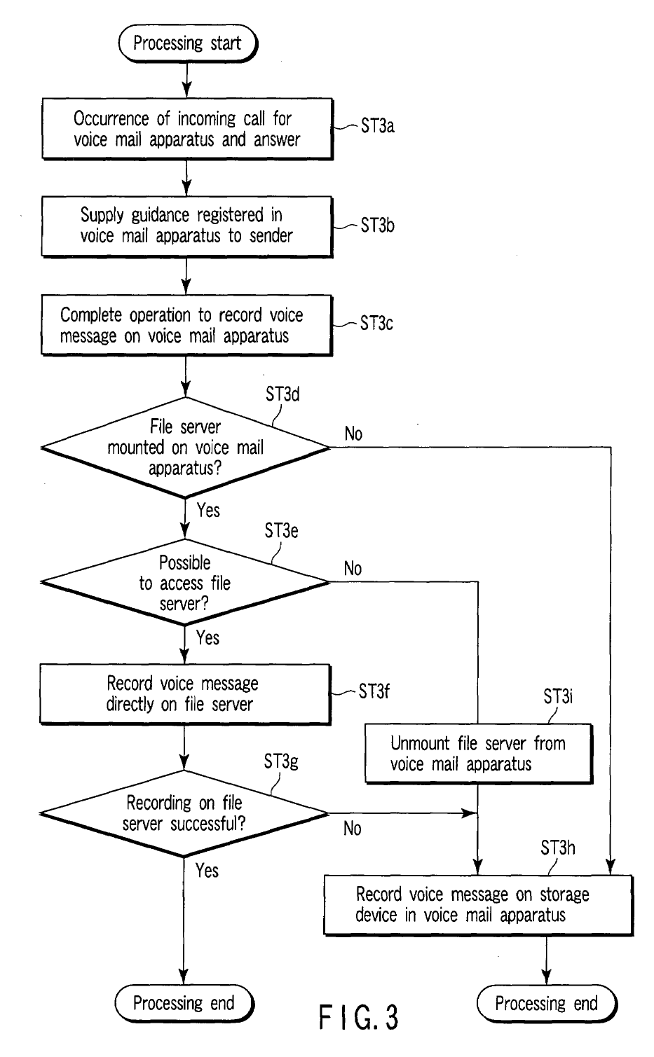

Next, operations of the system configured as described above will be explained below. FIG. 3 is a flowchart showing procedures executed by the CPU 151a when a voice message is recorded on the file server 3 and the contents of the procedures.

It is assumed here that there is received an incoming call for the extension terminal DKT1 from the public network PNW, and the incoming call is transferred to the voice mail apparatus 151 for the reason of absence or the like.

Having answered the incoming call (block ST3a), the CPU 151a reads out the prompt data registered in the program memory 151c, and supplies guidance to the sender on the basis of the prompt data (block ST3b).

When the sender performs an operation to record the voice message on the voice mail apparatus 151 in accordance with the guidance (block ST3c), the CPU 151a checks whether or not the file server 3 is mounted on the voice mail apparatus 151 (block ST3d).

When the file server 3 is mounted on the voice mail apparatus 151, the CPU 151a determines whether or not it is possible to access the file server 3 (block ST3e). When it is possible to access the file server 3, the CPU 151a transfers the recorded voice message to the file server 3 and records the voice message in the mailbox 31 of the file server 3 (block ST3f).

The CPU 151a then checks whether or not the processing of recording the voice message on the file server 3 is successful (block ST3g). When the processing of recording the voice message on the file server 3 is unsuccessful or when the file server 3 is not mounted on the voice mail apparatus 151 in step ST3d, the CPU 151a records the recording message in a mailbox provided in the storage device 151b in the voice mail apparatus 151 (block ST3h).

On the other hand, when it is impossible to access the file server 3 in step ST3e described above, the CPU unmounts the file server 3 from the voice mail apparatus 151 (block ST3i) and, thereafter moves to the processing of step ST3h described above.

As described above, in the first embodiment, the voice mail apparatuses 151 to 15m are connected to the file server 3 via the LAN 2 in order to be used in common, and the plural mailboxes 31 to 3p provided in the file server 3 are used in common with the voice mail apparatuses 151 to 15m in addition to the plural mailboxes originally provided in each of the voice mail apparatuses 151 to 15m. Further, a voice message which comes from the LAN 2 is converted into data having a format that can be processed in the respective voice mail apparatus 151 to 15m in order to be recorded in an arbitrary one of the mailboxes 31 to 3p, and the control program for playing back each of voice messages recorded in the mailboxes 31 to 3p in accordance with a playback instruction and the prompt data are stored in the file server 3.

Accordingly, in this system, it is not necessary to connect an external storage device to each of the voice mail apparatuses 151 to 15m, the plural mailboxes 31 to 3p provided in the file server 3 are used in common with the voice mail apparatuses 151 to 15m in addition to the plural mailboxes already provided in the respective voice mail apparatuses 151 to 15m. As a result, when one file server 3 is used in common with the plural voice mail apparatuses 151 to 15m, it is possible to enhance the effective utilization rate of the resource and provide a system having high reliability and low cost.

Further, since the plural voice mail apparatuses 151 to 15m share one file server 3, when the control program and the prompt data of the file server 3 are appropriately updated, the respective voice mail apparatuses 151 to 15m have only to copy the control program and the prompt data from the file server 3. As a result, the control program and the prompt data need not be updated for each of the plural voice mail apparatuses 151 to 15m, thereby making it possible to provide voice mail apparatuses requiring little time and labor in maintenance.

Further, in the first embodiment described above, in the voice mail apparatuses 151 to 15m, prior to execution of recording processing of a voice message to the server 3, it is determined whether or not a voice message can be recorded on the file server 3. Only when the voice message can be recorded on the file server 3 is the recording processing of the voice message executed with respect to the file server 3.

Accordingly, unnecessary access to the file server 3 can be prevented, thereby making it possible to further enhance the reliability of recording processing of the voice message, and reduce the load on the system and the load on the network. Further, since voice messages are accumulated in the file server 3, it is possible to easily cope with an increase in the accumulation amount of the messages by adding storage devices to the file server 3, and eliminate the limit on the accumulation capacity.

Moreover, in the first embodiment described above, when a voice message cannot be recorded on the file server 3, the voice message is recorded in a mailbox in the voice mail apparatus 151 corresponding to the extension terminal DKT1 which is the transmission destination of the voice message. As a result, it is possible to prevent an omission of recording of a message due to a failure or the like in the network from occurring, and provide a stable voice mail service.

### Second Embodiment

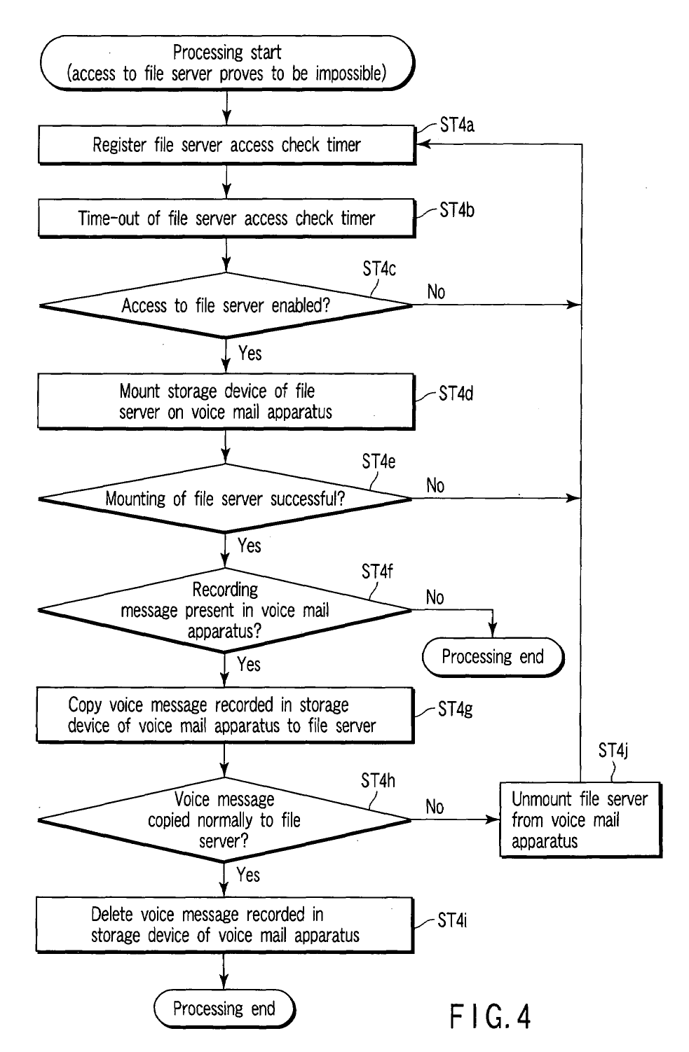

FIG. 4 is a flowchart showing, as a second embodiment of the present invention, procedures performed by a CPU 151a when a voice message cannot be recorded on a file server 3. Incidentally, the configuration of a communication system of a second embodiment is the same as that of the first embodiment, and a description will therefore be given with reference to FIGS. 1 and 2.

In this case, the CPU 151a of each of voice mail apparatuses 151 to 15m sets an access check timer of the file server 3 for periodically performing an access check on the file server 3 (block ST4a). When the access check timer of the file server 3 has counted up a time-out, the CPU 151a moves from block ST4b to step ST4c to confirm whether or not access to the file server 3 is enabled.

Further, when access to the file server 3 is enabled, the CPU 151a mounts the file server 3 (block ST4d). Then, the CPU 151a checks whether or not the file server 3 has been mounted normally (block ST4e).

In this case, when the file server 3 is mounted normally (YES), the CPU 151a checks whether or not a voice message has been recorded in the storage device 151b (block ST4f). When a voice message has been recorded therein (YES), the CPU 151a transfers the voice message recorded in the storage device 151b to the file server 3 in order to record (copy) it (block ST4g).

Then, the CPU 151a determines whether or not the voice message has been copied normally to the file server 3 (block ST4h) and, when the voice message is copied normally to the file server 3 (YES), the CPU 151a deletes the voice message recorded on the storage device 151b (block ST4i).

On the other hand, when the voice message is not copied normally to the file server 3 in step ST4h (NO), the CPU 151a unmounts the file server 3 from the voice mail apparatuses 151 to 15m (block ST4j), and moves to the processing of step ST4a.

Incidentally, when access to the file server 3 is not allowed in step ST4c (NG) or when the mounting of the file server 3 is unsuccessful in step ST4e (NG), too, the CPU 151a moves to the processing of step ST4a in order to set the access check timer of the file server 3 again.

As described above, in the second embodiment, for example, when the connection of the file server 3 to the voice mail apparatuses 151 to 15m is restored, and when a voice message is present in a mailbox in the voice mail apparatuses 151 to 15m, the voice message is transferred to the file server 3 in order to be recorded thereon. As a result, voice messages in the voice mail apparatuses 151 to 15m can be saved on the file server 3 without fail.

### Third Embodiment

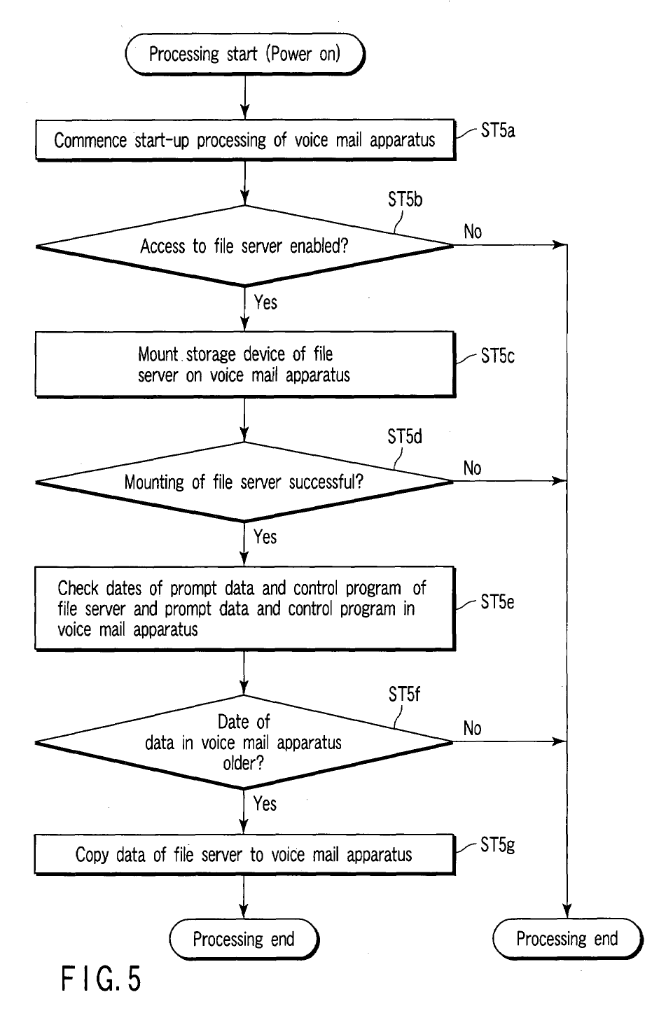

FIG. 5 is a flowchart showing, as a third embodiment of the present invention, procedures performed by a CPU 151a when voice mail apparatuses are started up. Incidentally, the configuration of a communication system of the third embodiment is the same as that of the first embodiment, and a description is therefore given with reference to FIGS. 1 and 2.

When the power source of a telephone exchange apparatus is turned on, and the start-up of the voice mail apparatuses 151 to 15m is commenced, the CPU 151a moves from block ST5a to block ST5b in order to check whether or not access to a file server 3 registered in the database 151e in each of the voice mail apparatuses 151 to 15m is enabled.

In this case, when access to the file server 3 is enabled, the CPU 151a mounts the file server 3 as an external storage device of the voice mail apparatuses 151 to 15m (block ST5c), and checks whether or not the file server 3 is mounted normally (block ST5d).

When the file server 3 is mounted normally (YES), the CPU 151a acquires the prompt data and the control program from the file server 3, and checks the dates of the acquired prompt data and control program and the prompt data and the control program of each of the voice mail apparatuses 151 to 15m (block ST5e). Then, the CPU 151a further determines whether or not the date of the prompt data and the control program of each of the voice mail apparatuses 151 to 15m is older than that of the prompt data and the control program of the file server 3 (block ST5f). When it is determined by this determination that the date of the prompt data and the control program of each of the voice mail apparatuses 151 to 15m is older than that of the prompt data and the control program of the file server 3, the CPU 151a moves from block ST5f to block ST5g, and copies the prompt data and the control program of the file server 3 to the program memory 151c of each of the voice mail apparatuses 151 to 15m.

On the other hand, when the date of the prompt data and the control program of each of the voice mail apparatuses 151 to 15m is the same as that of the prompt data and the control program of the file server 3 (NO), the CPU 151a terminates the processing as it is.

Furthermore, when access to the file server 3 is not allowed in block ST5b, or when the file server 3 cannot be mounted in block ST5d, too, the processing is terminated as it is.

As described above, in the third embodiment, each of the voice mail apparatuses 151 to 15m acquires the prompt data and the control program from the file server 3 at the operation start-up time. When the acquired prompt data and control program are newer than the prompt data and control program stored in the program memory 151c, each of the voice mail apparatuses 151 to 15m stores the acquired prompt data and control program in the program memory 151c, and executes processing of the voice message with respect to the mailbox.

Accordingly, even when a failure occurs in the network or in the file server 3, the voice mail service can be provided. Further, only when the control program and prompt data in the file server 3 are new are they copied to the voice mail apparatuses 151 to 15m, and the reliability in the use of the control program and prompt data can therefore be improved.

### Other Embodiments

The present invention is in no way limited to the embodiments described above. For example, in the second embodiment, an example has been explained in which, when a voice message is present in the mailboxes of the voice mail apparatuses 151 to 15m, the voice message is transferred to the file server 3 to be recorded thereon. However, the present invention is not limited to the example. When an external storage device is connected to each of the voice mail apparatuses 151 to 15m, a voice message present in the external storage device may be transferred to the file server 3 in order to be recorded thereon. As a result, for example, when the connection of the file server 3 is restored, it is possible to quickly transfer the voice message in the external storage device to the file server 3 in order to record the voice message on the file server 3 without waiting for a restoration operation of a maintenance engineer.

Furthermore, in the first embodiment, an example has been explained in which, when the voice mail apparatuses 151 to 15m can be connected to the file server 3, the voice mail apparatuses 151 to 15m each transfer the voice message to the file server 3 in order to record the voice message on the file server 3. Likewise, it goes without saying that the voice mail apparatuses 151 to 15m each can play back a voice message recorded in the mailbox in the file server 3 in response to a playback request.

Furthermore, in each of the embodiments described above, an example has been explained in which the plural voice mail apparatuses 151 to 15m are incorporated in the telephone exchange apparatus 1. However, the voice mail apparatuses 151 to 15m may be attached to the outside of the telephone exchange apparatus 1.

Moreover, in each of the embodiments described above, although an example has been explained in which the processing of recording the voice message on the file server 3 is performed by the CPU in the voice mail apparatus, the above processing may be performed by the central control unit of the telephone exchange apparatus or an external control unit.

In addition, the configuration and type of the system, the configuration and type of the telephone exchange apparatus, the type of the extension terminal, and the recording or playback control procedure of the voice message and the control contents thereof can be variously modified to be implemented within the scope not deviating from the gist of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system comprising:
a plurality of voice mail apparatuses each of which includes mailboxes corresponding to a plurality of telephone terminals, and records a voice message transmitted to any one of the plural telephone terminals in a mailbox corresponding to the telephone terminal; and
a file server which is connected to each of the plural voice mail apparatuses via a network and includes a plurality of common mailboxes to be used in common with the plurality of voice mail apparatuses, wherein
each of the plurality of voice mail apparatuses include a controller which transfers the voice message to the file server via the network in order to record the voice message in any one of the common mailboxes, when there is a request to record the voice message.

2. The communication system according to claim 1, wherein the controller transfers the voice message to the file server via the network in order to record the voice message in a common mailbox corresponding to the telephone terminal as source of request, when it is requested to record the voice message.

3. The communication system according to claim 2, wherein the controller determines whether or not the voice message can be recorded on the file server, transfers the voice message to the file server via the network in order to record the voice message in a common mailbox corresponding to the telephone terminal as source of request, based on the determination result, when it is requested to record the voice message.

4. The communication system according to claim 3, wherein the controller records the voice message in a mailbox of the voice mail apparatus corresponding to the telephone terminal as source of request, when it is determined in the determination that the voice message cannot be recorded on the file server.

5. The communication system according to claim 3, wherein the controller transfers the voice message to the file server via the network in order to record the voice message in a common mailbox corresponding to the telephone terminal as source of request, when the voice message can be recorded on the file server according to the determination result, and the voice message is recorded in a mailbox of the voice mail apparatus.

6. The communication system according to claim 2, when an external storage device is connected to each of the voice mail apparatuses, and the recording processing of the voice message has not been performed for a predetermined period of time, and a voice message is present in the external storage device connected to the voice mail apparatus, wherein the controller determines whether or not the voice message can be recorded on the file server, and when the voice message can be recorded on the file server based on the determination result, the controller transfers the voice message stored in the external storage device to the file server via the network in order to record the voice message in any one of the common mailboxes.

7. The communication system according to claim 1, when a control program and guidance data for recording the voice message in a mailbox are stored in each of the plural voice mail apparatuses and the file server, wherein the controller acquires the control program and the guidance data from the file server at the start-up time of the voice mail apparatus, and performs processing of the voice message with respect to the mailbox based on the acquired control program and guidance data.

8. The communication system according to claim 7, wherein, the controller compares the acquired control program and guidance data with the stored control program and guidance data, and only when the acquired control program and guidance data are new, the controller processes the voice message with respect to the mailbox based on the acquired control program and guidance data.

9. A voice message processing method used in a communication system comprising: a plurality of voice mail apparatuses each of which includes mailboxes corresponding to a plurality of telephone terminals, and records a voice message transmitted to any one of the plural telephone terminals in a mailbox corresponding to the telephone terminal; and a file server which is connected to each of the plurality of voice mail apparatuses via a network and includes a plurality of common mailboxes to be used in common with the plurality of voice mail apparatuses, wherein
each of the plural voice mail apparatuses transfers the voice message to the file server via the network in order to record the voice message in any one of the common mailboxes, when there is a request to record the voice message.
